(19) United States
(12) Patent Application Publication
(10) Pub. No.: US 2020/0042902 A1
(43) Pub. Date: Feb. 6, 2020

(54) Method for Building User Visit Inference Model, Apparatus and Storage Medium

(71) Applicant: Baidu Online Network Technology (Beijing) Co., Ltd., Beijing (CN)

(72) Inventors: Yanyan LI, Beijing (CN); Renjun HU, Beijing (CN); Jianguo DUAN, Beijing (CN); Airong JIANG, Beijing (CN); Hui XIONG, Beijing (CN)

(73) Assignee: Baidu Online Network Technology (Beijing) Co., Ltd., Beijing (CN)

(21) Appl. No.: 16/654,343

(22) Filed: Oct. 16, 2019

(30) Foreign Application Priority Data
Oct. 25, 2018 (CN) 201811252456.1

(51) Int. Cl. G06N 20/00; G06N 5/04

(52) U.S. Cl. CPC G06N 20/00; G06N 5/04

(57) ABSTRACT

The present disclosure provides a method for building a user visit inference model, an apparatus and a storage medium. According to positioning data of each user in a plurality of users, a set of staying points of the each user is determined, wherein the set of staying points is a cluster set of staying points; according to the sets of staying points of all users, a group relationship of the users is formed; according to the set of staying points of the each user, a visit relationship of the each user is formed; and vector characterization learning is performed on the group relationship and the visit relationships that are formed to obtain the user visit inference model. In the user visit inference model obtained by the above building method, the user group relationship and the visit relationship, and has higher prediction accuracy compared with the solution of the prior art.

### CROSS-REFERENCE TO RELATED APPLICATION

This application claims priority to Chinese Patent Application No. 201811252456.1, filed on Oct. 25, 2018, which is hereby incorporated by reference in its entirety.

### TECHNICAL FIELD

Embodiments of the present disclosure relate to the field of information processing technologies, and in particular, to a method for building a user visit inference model, an apparatus and a storage medium.

### BACKGROUND

With the continuous development of the mobile internet and mobile intelligent terminal, end users generate a large amount of positioning data that truly reflects behavior feature of the users in the physical world. Inferring a user visit point of interest (POI) based on the user positioning data enriches information about a user positioning point, which is widely used in the fields of user persona, mapping knowledge domains, search advertisements, and the like. Specifically, if it can be determined or predicted that the user visits a POI, such as a shopping mall, a scenic spot, the actual demand of the user can be accurately predicted, thereby pushing information to the end users.

At present, the visit POI inference is mainly performed based on a shortest distance modeling manner, a Bayesian modeling manner and a WIFI signal modeling manner. The shortest distance modeling manner refers to sorting distance relationships between the user positioning point and POIs' coordinates, and the nearest POI is the visit POI. In the Bayesian modeling manner, more features are considered, such as a visit time, POI popularity and a distance factor, and the features have conditional independence. In WIFI signal intensity modeling manner, a WIFI name and intensity feature scanned during user positioning is used, which is inputted to a classification model, such as a support vector machine (SVM), to rate surrounding POIs.

The above three solutions are main manners for inference of a visit POI in the industry and academia. Comprehensively, whether based on simple rules or classification models, the related feature such as the user's social relationship and historical travel rules cannot be conveniently characterized and embedded, resulting in the lack of feature information and in poor inference.

### SUMMARY

In a method for building a user visit inference model, a device and a storage medium provided by the present disclosure, since a user group relationship and a user historical visit relationship are embedded in the model, the accuracy of prediction is high.

A first aspect of the present disclosure provides a method for building a user visit inference model, including:

determining, according to positioning data of each user in a plurality of users, a set of staying points of the each user, wherein the set of staying points is a cluster set of staying points;

forming, according to the sets of staying points of all users, a group relationship of the users;

forming, according to the set of staying points of the each user, a visit relationship of the each user; and

performing vector characterization learning on the group relationship and the visit relationship of the each user that are formed, to obtain the user visit inference model.

In a possible implementation, the positioning data comprise a position coordinate of each positioning point of the each user, a first moment when the each user reached the each positioning point, and a second moment when the each user left the each positioning point, and the determining, according to positioning data of each user in a plurality of users, a set of staying points of the each user comprises:

determining, according to the first moment and the second moment, a staying time length of the each user at the each positioning point;

taking a positioning point at which a staying time length is greater than a preset staying time length as the staying point of each user; and

clustering a plurality of staying points between which distance is less than preset distance, to determine the set of staying points of the each user.

In a possible implementation, the forming, according to the sets of staying points of the users, a group relationship of the users comprises:

determining, according to the sets of staying points of the users, a first set of users, wherein the first set of users comprise at least two users who simultaneously appeared at at least one same staying point;

counting, in a preset time period, a first number of times that the at least two users in the first user set simultaneously appeared at the at least one same staying point; and

forming, according to the first set of users and the first number of times, the group relationship of the users.

In a possible implementation, the forming, according to the set of staying points of the each user, a visit relationship of the each user comprises:

determining, according to the set of staying points of the each user and connection information of the each user connecting to a local area network, a visit set of the each user, wherein the visit set comprises a plurality of visit POIs;

counting, in a preset time period, a second number of times that the each user reached each visit POI in the visit set; and

forming, according to the visit set and the second number of times, the visit relationship of the each user.

In a possible implementation, the performing vector characterization learning on the group relationship and the visit relationship of the each user that are formed, to obtain the user visit inference model comprises:

performing, based on a GraphEmbeding algorithm, the vector characterization learning on the group relationship and the visit relationship of the each user that are formed, to obtain the user visit inference model.

In a possible implementation, the performing, based on a GraphEmbeding algorithm, the vector characterization learning on the group relationship and the visit relationship of the each user that are formed, to obtain the user visit inference model, comprises:

performing, based on the GraphEmbeding algorithm, the vector characterization learning on the group relationship that is formed, to obtain a first objective function of the group relationship;

performing, based on the GraphEmbeding algorithm, the vector characterization learning on the visit relationships that are formed, to obtain a second objective function of the visit relationships; and

determining, according to the first objective function and the second objective function, the user visit inference model.

In a possible implementation form, the determining, according to the first objective function and the second objective function, the user visit inference model comprises:

determining, using a stochastic gradient descent algorithm, the user visit inference model according to the first objective function and the second objective function.

A second aspect of the present disclosure provides an apparatus for building a user visit inference model, including:

a determining module, configured to determine, according to positioning data of each user in a plurality of users, a set of staying points of the each user, wherein the set of staying points is a cluster set of staying points;

a group relationship forming module, configured to form, according to the sets of staying points of all users, a group relationship of the users;

a visit relationship forming module, configured to form, according to the set of staying points of the each user, a visit relationship of the each user; and

a model building module, configured to perform vector characterization learning on the group relationship and the visit relationship of the each user that are formed, to obtain the user visit inference model.

A third aspect of the present disclosure provides an apparatus for building a user visit inference model, including:

a memory;

a processor; and

a computer program;

where the computer program is stored in the memory, and is configured to be executed by the processor to implement the method for building a user visit inference model according to any one of the first aspect and implementations thereof of the present disclosure.

A fourth aspect of the present disclosure provides a computer readable storage medium having a computer program stored thereon, where the computer program is executed by a processor to implement the method for building the user visit inference model according to any one of the first aspect and implementations thereof of the present disclosure.

The embodiments of the present disclosure provide a method for building a user visit inference model, an apparatus and a storage medium. According to positioning data of each user in a plurality of users, a set of staying points of the each user is determined, wherein the set of staying points is a cluster set of staying points; according to the sets of staying points of all users, a group relationship of the users is formed; according to the set of staying points of the each user, a visit relationship of the each user is formed; and vector characterization learning is performed on the group relationship and the visit relationships that are formed to obtain the user visit inference model. In the user visit inference model obtained by the above building method, the user group relationship and the user history visit relationship, and has higher prediction accuracy compared with the solution of the prior art.

### BRIEF DESCRIPTION OF THE DRAWINGS

The accompanying drawings herein are incorporated into the specification and form part of the specification, showing embodiments consistent with the present disclosure, and the accompanying drawings are used together with the specification to explain the principles of the present disclosure.

FIG. 1 is a schematic flowchart of a method for building a user visit inference model according to an embodiment of the present disclosure;

FIG. 2 is a schematic flowchart of a method for building a user visit inference model according to another embodiment of the present disclosure;

FIG. 3 is a schematic diagram of a distribution of user staying points according to an embodiment of the present disclosure;

FIG. 4 is a schematic structural diagram of an apparatus for building a user visit inference model according to an embodiment of the present disclosure; and

FIG. 5 is a schematic structural diagram of hardware of an apparatus for building a user visit inference model according to an embodiment of the present disclosure.

The embodiment of the present disclosure has been clearly illustrated through the previous accompanying drawings and will be described in detail below. These drawings and the written description are not intended to limit the scope of the present disclosure in any way, instead, they are intended to illustrate the concept of the present disclosure for those skilled in in the art through reference to specific embodiments.

### DESCRIPTION OF EMBODIMENTS

Exemplary embodiments, whose examples are shown in the accompanying drawings, will be described in detail herein. When the following description refers to the accompanying drawings, unless otherwise indicated, the same number in different accompanying drawings represents the same or a similar element. Embodiments described in the following exemplary embodiments do not represent all embodiments consistent with the present disclosure. Instead, they are merely examples of apparatuses and methods consistent with some aspects of the present disclosure as detailed in the appended claims.

Terms “including”, “comprising” and any variations thereof are intended to reference a non-exclusive inclusion. For example, a process, a method, a system, a product, or a device that includes a series of steps or units is not necessarily limited to those steps or units that are clearly listed, but may optionally include steps or units that are not clearly listed or that are inherent to such process, method, product or device.

Terms “first”, “second” and the like in the specification, the claims and the above-mentioned accompanying drawings of the present disclosure are used to distinguish similar objects and do not necessarily describe a specific order or sequence. It should be understood that data used in this way is interchangeable where appropriate so that the embodiments of the disclosure described herein can be implemented in a sequence other than those illustrated or described herein.

The phrase “an embodiment” or “another embodiment” as used throughout the specification means that a particular feature, structure, or feature relating to an embodiment is included in at least one embodiment of the present application. Therefore, “in some embodiments” or “in the present embodiment” used throughout the specification does not necessarily mean the same embodiment. It should be noted that, the embodiments in the present disclosure and features in the embodiments may be combined with each other without conflict.

In a method for building a user visit inference model according to the present embodiment, a user visit inference model is built based on a priori observation of a user visit, with following observation factors being specifically considered:

observation factor 1: Tobler's First Law of Geography. An absolute influence exists between a human's behavior and the area where the human is located, and this influence decreases as distance increases;

observation factor 2: spatial regularity. In a space, when a same user is within a distance from approximate positioning point, the user tends to visit the similar or the same POI;

observation factor 3: time regularity. A user tends to visit a similar or a same POI at a similar time;

observation factor 4: social regularity. A group of people having a social relationship with each other tend to reach a similar or a same POI, for example, a couple go shopping together in a supermarket.

In the method for building a user visit inference model according to the present embodiment, features of the above-mentioned observation factors are involved, and innovatively, vector characterization learning is performed on features of a group relationship and historical visit preference. Feature encoding is performed on heterogeneous data of the group relationship and historical visit relationships by a characterized algorithm. Compared with the current implementation solution, the model has higher prediction accuracy due to consideration of the group relationship and historical visit preference features.

The technical solutions of the present disclosure will be described in detail below with reference to specific embodiments. The following specific embodiments may be combined with each other, and the same or similar concepts or processes may not be repeated in some embodiments.

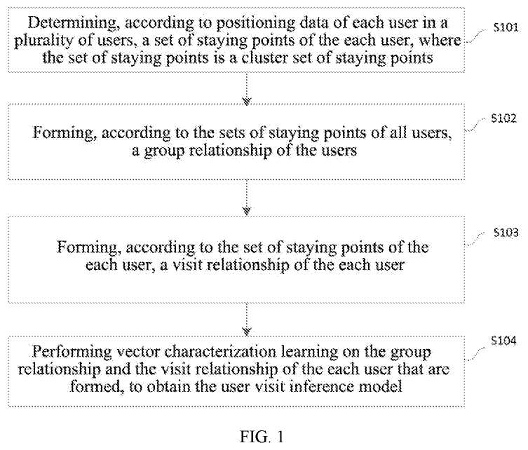

FIG. 1 is a schematic flowchart of a method for building a user visit inference model according to an embodiment of the present disclosure. The method may be performed by any apparatus that performs the method, and the apparatus may be implemented by software and/or hardware. As shown in FIG. 1, the method for building a user visit inference model according to the present embodiment includes following steps:

S101: determining, according to positioning data of each user in a plurality of users, a set of staying points of the each user, wherein the set of staying points is a cluster set of staying points.

In the present embodiment, the positioning data of the each user refers to historical positioning data of the each user within a preset time period. For example, the preset time period may be one year or one quarter, which is not specifically limited by the present embodiment and may be set by those skilled in the art according to actual needs.

The set of staying points of each user is determined according to the historical positioning data of each user. For a certain user, the historical positioning data of that user includes a large amount of positioning point information. First, the large amount of positioning point information needs to be initially filtered to acquire staying points of the user. It can be understood that not all positioning points are staying points. In other words, if the user stayed at a positioning point for a very short time, then the positioning point is not a staying point, and if the user stayed at a positioning point for a relatively long time, then the positioning point may be taken as a staying point of the user. Then, the staying points that are acquired after the filtering are clustered to obtain the set of staying points of the user.

S102: forming, according to the sets of staying points of all users, a group relationship of the users;

On the basis of step S101, the sets of staying points of all users in a set of users are obtained, and the group relationship of the users is formed according to the sets of staying points of the users. Specifically, a first set of users is determined according to the sets of staying points of all users, where the first set of users includes at least two users who simultaneously appeared at a same staying point, and the group relationship of the users is formed according to a plurality of the first sets of users.

For example, user u and user u′ simultaneously appeared in a supermarket at 14 o'clock and stayed in the supermarket for half an hour. And user u and user u′ simultaneously appeared in a mall at 19 o'clock and stayed in the mall for an hour, then it can be determined that user u has a group relationship with user u′.

S103: forming, according to the set of staying points of the each user, a visit relationship of the each user.

On the basis of step S101, a visit set of the each user is determined according to the set of staying points of the each user, where the visit set includes a plurality of visit POIs. Specifically, the visit set of the each user is determined according to the set of staying points of the each user and connection information of the each user connecting to a local area network, and the visit relationship of each user is formed according to the visit set, that is, actual visit information of the each user is determined.

In the present embodiment, the local area network is connected, including but not limited to a WIFI connection. According to the each user's sign-in data, payment data, consumption data, etc. during the connection to the local area network, behavior data of the each user at the staying point may be determined.

S104: performing vector characterization learning on the group relationship and the visit relationship of the each user that are formed, to obtain the user visit inference model.

Specifically, in the present embodiment, the vector characterization learning is performed on the group relationship and the visit relationships that are formed based on the GraphEmbeding algorithm, to obtain the user visit inference model.

The GraphEmbeding algorithm is a characterization algorithm capable of retaining the first-order proximity. Optionally, the DNGR, GCN, LINE, HOPE and other algorithms may be used to perform vector characterization learning on the group relationship and the visit relationship of the present embodiment.

In the method for building the user visit inference model according to the present embodiment of the present disclosure, the set of staying points of the each user is determined according to the positioning data of the each user, where the set of staying points is a cluster set of staying points, the group relationship of the users is formed according to the sets of the staying points of the users, the visit relationship of the each user is formed according to the set of staying points of the each user, and the vector characterization learning is performed on the group relationship and the visit relationships that are formed, to obtain the user visit inference model. In the user visit inference model obtained by the above building method, the user group relationship and the user historical visit relationships are embedded, and the user visit inference model obtained by the above building method has higher prediction accuracy compared with the solution in the prior art.

On the basis of the preceding embodiment, in the method for building a user visit inference model, weighting of number of times in the time dimension is added, and an obtained user visit inference model has a more accurate prediction effect. The method for building a user visit inference model according to the present embodiment will be described in detail below with reference to the accompanying drawings.

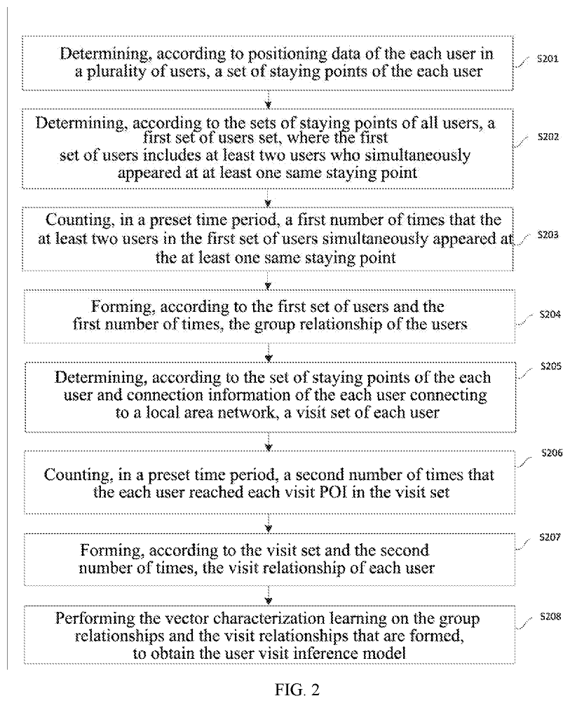

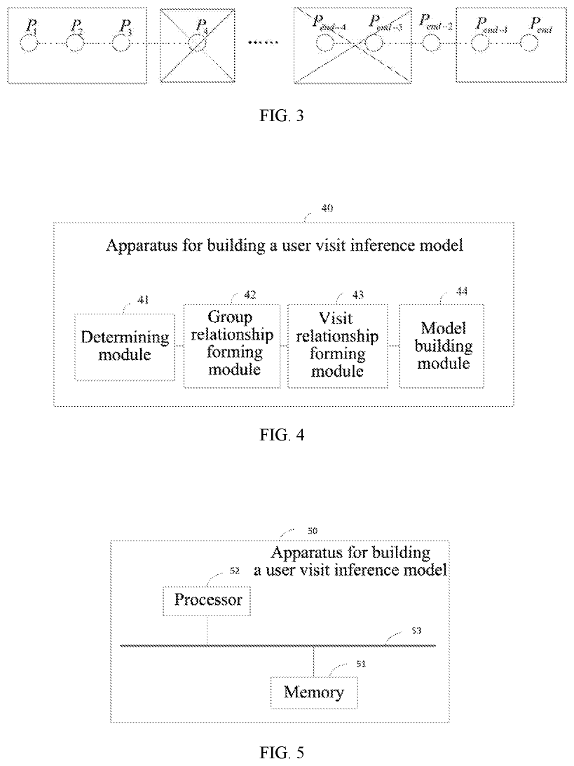

FIG. 2 is a schematic flowchart of a method for building a user visit inference model according to another embodiment of the present disclosure, and FIG. 3 is a schematic diagram of a distribution of user staying points according to an embodiment of the present disclosure. As shown in FIG. 2, the method for building the user visit inference model according to the present embodiment specifically includes following steps:

S201: determining, according to positioning data of the each user in a plurality of users, a set of staying points of the each user.

In the present embodiment, the positioning data of each user includes a positioning coordinate of each positioning point of the each user, a first moment when the each user reached the each positioning point, and a second moment when the user left the each positioning point.

Specifically, for a certain user, a staying time length of the user at a positioning point may be determined according to the first moment and the second moment of the positioning point of the user. A positioning point at which a staying time length is greater than a preset staying time length is taken as a staying point of the user, and a plurality of staying points between which distance is less than preset distance are clustered, to determine the set of staying points of the user.

As shown in FIG. 3, the positioning points of the user u include P₁, P₂, . . . , P_{end}. Since staying time lengths at P₄, P_{end-4}, and P_{end-3} are less than the preset staying time length, P₄, P_{end-4}, and P_{end-3} are filtered out (non-staying points), further, since distance between P₁, P₂ and P₃ is less than the preset distance, P₁, P₂ and P₃ are clustered into one staying point, similarly, P_{end-1} and P_{end} are clustered into one staying point.

S202: determining, according to the sets of staying points of all users, a first set of users set, where the first set of users includes at least two users who simultaneously appeared at at least one same staying point.

It should be pointed out that the two users simultaneous appeared at a same staying point means that a time intersection exists in the time when the two users appeared at a preset range of a same staying point. For example, user u entered a supermarket at 14:02 and left the supermarket at 14:30, and user u′ entered the supermarket at 13:50 and left the supermarket at 14:30, then it is determined that a time intersection exists between the times when user u and user u′ visited the supermarket.

S203: counting, in a preset time period, a first number of times that the at least two users in the first set of users simultaneously appeared at the at least one same staying point.

In the present embodiment, after the group relationship of all users in the sets of users is determined, a time-division dimension weight w is added, which considers closeness of the group relationship, and specifically, in a preset time period, the total number of times that the at least two users in the first user set simultaneously appeared at a same staying point is counted, in order to make the formed group relationship more accurate.

For example, the preset time period is set to be 24 hours, and the 24 hours are divided into 24 time segments, and the numbers of times that the at least two users simultaneously appeared at same staying points in the time segments is counted and may be expressed with a vector w(u, u′)=[n₁, n₂, . . . , n_{T}], and the first number of times of the present embodiment is a sum of all the numbers of times in the vector. The above preset time period is only an example, and the preset time period is not specifically limited in the present embodiment.

S204: forming, according to the first set of users and the first number of times, the group relationship of the users.

In the present embodiment, the first set of users are weighted by the number of times to form the group relationship of the users. Since the total number of times that the users simultaneous appeared in the time dimension is taken into account, the obtained group relationship is more accurate than the preceding embodiment.

S205: determining, according to the set of staying points of the each user and connection information of the each user connecting to a local area network, a visit set of each user;

where the visit set includes a plurality of visit POIs.

The implementation principles and technical effect of S205 in the present embodiment is the same as S103 in the preceding embodiment, which may be referred to the preceding embodiment for details, which will not be repeated herein.

S206: counting, in a preset time period, a second number of times that the each user reached each visit POI in the visit set.

In some embodiments, after the visit set of each user is determined, it is also required to count the second number of times that the each user reached each visit POI in the visit set during the preset time period, so as to sort the number of times that the each user actually visited each visit POI in the visit set. The second numbers of times corresponding to different visit POIs are different, and the greater the second number is, the greater the weight of the visit POI is.

For example, the preset time period is set to be 1 year, and the 1 year is divided into 12 months, and the numbers of times that the user visited the POIs in each month is counted and may be expressed with a vector w(u, p)=[n₁, n₂, . . . , n_{T}], where p is the visit POIs in the visit set, and the second number of times in the present embodiment is a sum of all the numbers of times in the vector. The above preset time period is only taken an example, and the preset time period is not specifically limited in the present embodiment.

S207: forming, according to the visit set and the second number of times, the visit relationship of the each user.

In the present embodiment, the visit set is weighted by the number of times to form the group relationship of each user. Since the total number of times that each visit POI is visited in the time dimension is considered, the obtained visit relationship of each user is more accurate than that the preceding embodiment.

S208: performing vector characterization learning on the group relationship and the visit relationship of the each user that are formed, to obtain the user visit inference model.

Based on the preceding embodiment, in the present embodiment, the vector learning on the formed group relationship is performed based on the GraphEmbeding algorithm, to obtain a first objective function of the group relationship, the vector learning is performed on the formed visit relationship based on the GraphEmbeding algorithm, to obtain a second objective function of the visit relationship, and the user visit inference model is obtained based on the first objective function and the second objective function.

Specifically, the first objective function of the present embodiment is expressed as:

O₁(u,u′,t)=−log σ(\vec{uₜ}·\vec{u′ₜ})−E_{u″˜D}_{ᵤ}_{,t′˜D}_{_{T}} log σ(−\vec{u_{t′}}·\vec{u_{t′}″}).

Where \vec{uₜ} is a vector characterization of user u at time t, \vec{u′ₜ} is a vector characterization of user u′ at time t, σ(\vec{uₜ}·\vec{u′ₜ}) and σ(−\vec{u′ₜ}·\vec{u′ₜ″}) are the sigmoid function, u″ is a user following the discrete uniform distribution D_{U}, t′ is a time following the discrete uniform distribution D_{T}, and E is a mathematical expectation.

Specifically, the second objective function of the present embodiment is expressed as:

O₂(u,p,t)=−log σ(\vec{uₜ}·\vec{p})−E_{p′˜D}_{_{P}}_{,t′˜D}_{_{T}} log σ(−\vec{u′ₜ}·\vec{p′}).

Where \vec{uₜ} is the vector characterization of user u at time t, and \vec{p} is the vector characterization of the visit POI by the user u, σ(\vec{uₜ}·\vec{p}) and σ(−\vec{u′ₜ}·\vec{p′}) is the sigmoid function, p′ is a POI following the discrete uniform distribution D_{P}, t′ is a time following the discrete uniform distribution D_{T}, and E is a mathematical expectation.

An overall loss function is given according to the first objective function and the second objective function, and the overall loss function is expressed as:

O=Σ_{(u,p,t)∈s}_{ᵥ}_{⁺}O₂(u,p,t)+λΣ_{(u,u′,t)∈s}_{ₛ}_{⁺}O₁(u,u′,t).

Where Sₛ⁺ a set of the group relationships of the users, and Sᵥ⁺ is a set of the visit relationships of the users.

λ is used to adjust a ratio of the first objective function to the second objective function.

In the present embodiment, a stochastic gradient descent algorithm is used to obtain the optimal solution of the overall loss function, so that the overall loss function O is minimized, and at this time, the overall loss function can be used as the mathematical expression of a final user visit inference model.

Based on the above-mentioned user visit inference model, the vector characterization \vec{uₜ} of user u and the vector characterization \vec{p} of the visit POI of user u can be inputted to obtain an accurate visit probability.

In the method for building a user visit inference model according to the present embodiment of the present disclosure, the set of staying points of each user is determined according to the positioning data of each user, the first set of users is determined according to the sets of staying points of all users, the first number of times that the at least two user in the first set of users appeared at a same staying point in a preset period of time is counted to form the group relationship of the users, the visit set of each user is determined according to the set of staying points of each user and the connection information of the user connecting the local area network, the second number of times that each user reached each visit POI in the visit set in a preset period of time is counted, the visit relationship of each user is formed according to the visit set, and the vector characterization learning is performed on the group relationship and the visit relationship that are formed to obtain the user visit inference model. In the above building model, the group relationship of users and the historical visit relationship of the user are embedded in the user visit inference model, and the weighting of number of times in the time dimension is also added, so that the method has a more accurate prediction result.

FIG. 4 is a schematic structural diagram of an apparatus for building a user visit inference model according to an embodiment of the present disclosure. As shown in FIG. 4, the apparatus or building the user visit inference model 40 according to the present embodiment includes:

a determining module 41, configured to determine, according to positioning data of each user in a plurality of users, a set of staying points of the each user, wherein the set of staying points is a cluster set of staying points;

a group relationship forming module 42, configured to form, according to the sets of staying points of all users, a group relationship of the users;

a visit relationship forming module 43, configured to form, according to the set of staying points of the each user, a visit relationship of the each user; and

a model building module 44, configured to perform vector characterization learning on the group relationship and the visit relationship of the each user that are formed, to obtain the user visit inference model.

The apparatus for building the user visit inference model according to the present embodiment of the present disclosure includes the determining module, the group relationship building module, the visit relationship building module, and the model building module. The determining module is configured to determine, according to positioning data of each user in a plurality of users, a set of staying points of the each user, where the set of staying points is a cluster set of staying points; the group relationship forming module is configured to form, according to the sets of staying points of all users, a group relationship of the users; the visit relationship forming module is configured to form, according to the set of staying points of the each user, a visit relationship of the each user; and the model building module is configured to perform vector characterization learning on the group relationship and the visit relationship of the each user that are formed, to obtain the user visit inference model. In the apparatus for building the user visit inference model according to the present embodiment, the group relationship forming module and the visit relationship forming module are embedded, so that the built user visit model has high prediction accuracy.

On the basis of the preceding embodiment, optionally, the positioning data includes a position coordinate of each positioning point of the each user, a first moment when the each user reached the each positioning point, and a second moment when the each user left the each positioning point, and the determining module 41 is specifically configured to:

determine, according to the first moment and the second moment of the positioning point, a staying time length of the each user at the each positioning point;

take a positioning point at which a staying time length is greater than a preset staying time length as the staying point of each user; and

cluster a plurality of staying points between which distance is less than preset distance, to determine the set of staying points of the each user.

Optionally, the group relationship forming module 42 is specifically configured to:

determine, according to the sets of staying points of the users, a first set of users, wherein the first set of users comprise at least two users who simultaneously appeared at a same staying point;

count, in a preset time period, a first number of times that the at least two users in the first user set simultaneously appeared at a same staying point; and

form, according to the first set of users and the first number of times, the group relationship of the users.

Optionally, the visit relationship building module 43 is configured to:

determining, according to the set of staying points of the each user and connection information of the each user connecting to a local area network, a visit set of the each user, wherein the visit set comprises a plurality of visit POIs;

count, in a preset time period, a second number of times that the each user reached each visit POI in the visit set; and

form, according to the visit set and the second number of times, the visit relationship of the each user.

Optionally, the model building module 44 is specifically configured to:

perform, based on a GraphEmbeding algorithm, the vector characterization learning on the group relationship and the visit relationship of the each user that are formed, to obtain the user visit inference model.

Optionally, the model building module 44 is specifically configured to:

perform, based on the GraphEmbeding algorithm, the vector characterization learning on the group relationship that is formed, to obtain a first objective function of the group relationship;

perform, based on the GraphEmbeding algorithm, the vector characterization learning on the visit relationships that are formed, to obtain a second objective function of the visit relationships; and

determine, according to the first objective function and the second objective function, the user visit inference model.

Optionally, the model building module 44 is specifically configured to:

determine, using a stochastic gradient descent algorithm, the user visit inference model according to the first objective function and the second objective function.

The apparatus for building the user visit inference model according to the present embodiment may perform the technical solutions of the preceding method embodiment, and the implementation principles and the technical effects are similar, which will not be repeated herein.

Referring to FIG. 5, the present embodiment of the present disclosure further provide an apparatus for building a user visit inference model. FIG. 5 is only taken as an example for illustration of the present embodiment, but the present disclosure is not limited thereto.

FIG. 5 is a schematic structural diagram of hardware of an apparatus for building a user visit inference model according to an embodiment of the present disclosure. As shown in FIG. 5, an apparatus for building a user visit inference model 50 according to the present embodiment includes:

a memory 51;

a processor 52; and

a computer program;

where the computer program is stored in the memory 51, and is configured to be executed by the processor 52 to implement the technical solution according to any one of the preceding method embodiments, and the implementation principles and technical effects are similar, which will not be repeated herein.

Optionally, the memory 51 may be independent, or may be integrated with the processor 52.

When the memory 51 is a component independent of the processor 52, the apparatus for building a user visit inference model 50 further includes:

A bus 53, configured to connect the memory 51 and the processor 52.

The present embodiment of the present disclosure further provides a computer readable storage medium having a computer program stored thereon, and the computer program is executed by the processor 52 to implement the steps performed by the apparatus for building a user visit inference model 50 in the preceding method embodiment.

It should be understood that the above processor may be a central processing unit (CPU), or may be other general processor, a digital signal processor (DSP), an application specific integrated circuit (ASIC), etc. The general processor may be a microprocessor, or the processor may be any conventional processor or the like. Steps of the method disclosed in the present disclosure may be directly implemented as a hardware processor, or may be performed by a combination of hardware and software modules in the processor.

The memory may include a high speed RAM memory, and may also include a non-volatile memory NVM, such as at least one disk memory, and the memory may also be a USB flash drive, a removable hard disk, a read only memory, a magnetic disk, or an optical disk.

The bus may be an industry standard architecture (ISA) bus, a peripheral component (PCI) bus, or an extended industry standard architecture (EISA) bus. The bus can be divided into an address bus, a data bus, a control bus, and the like. For ease of characterization, the bus in the drawings of the present application is not limited to only one bus or one type of bus.

The above storage medium may be implemented by any type of volatile or non-volatile storage device or by a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or an optical disk. The storage medium may be any available media that can be accessed by a general purpose or special purpose computer.

An exemplary storage medium is coupled to the processor to enable the processor to read information from, and write information to, the storage medium. Of course, the storage medium may also be an integral part of the processor. The processor and the storage medium may be located in application specific integrated circuits (ASIC). Of course, the processor and the storage medium may also exist as discrete components in an electronic device or a master device.

Finally, it should be noted that the above embodiments are merely for illustrating, instead of limiting, the technical solutions of the present application. Although the present application has been illustrated in detail with reference to the above embodiments, a person ordinarily skilled in the art should understand the technical solutions described in the above embodiments may be modified or equivalently substituted for some or all of the technical features, and the modifications and substitutions should do not cause the essence of the corresponding technical solutions depart from the scope of the technical solutions of the embodiments of the present application.

What is claimed is:

1. A method for building a user visit inference model, comprising:
determining, according to positioning data of each user in a plurality of users, a set of staying points of the each user, wherein the set of staying points is a cluster set of staying points;
forming, according to the sets of staying points of all users, a group relationship of the users;
forming, according to the set of staying points of the each user, a visit relationship of the each user; and
performing vector characterization learning on the group relationship and the visit relationship of the each user that are formed, to obtain the user visit inference model.

2. The method according to claim 1, wherein the positioning data comprise a position coordinate of each positioning point of the each user, a first moment when the each user reached the each positioning point, and a second moment when the each user left the each positioning point, and the determining, according to positioning data of each user in a plurality of users, a set of staying points of the each user comprises:
determining, according to the first moment and the second moment, a staying time length of the each user at the each positioning point;
taking a positioning point at which a staying time length is greater than a preset staying time length as the staying point of each user; and
clustering a plurality of staying points between which distance is less than preset distance, to determine the set of staying points of the each user.

3. The method according to claim 1, wherein the forming, according to the sets of staying points of the users, a group relationship of the users comprises:
determining, according to the sets of staying points of the users, a first set of users, wherein the first set of users comprise at least two users who simultaneously appeared at at least one same staying point;
counting, in a preset time period, a first number of times that the at least two users in the first user set simultaneously appeared at the at least one same staying point; and
forming, according to the first set of users and the first number of times, the group relationship of the users.

4. The method according to claim 1, wherein the forming, according to the set of staying points of the each user, a visit relationship of the each user comprises:
determining, according to the set of staying points of the each user and connection information of the each user connecting to a local area network, a visit set of the each user, wherein the visit set comprises a plurality of visit point of interests (POIs);
counting, in a preset time period, a second number of times that the each user reached each visit POI in the visit set; and
forming, according to the visit set and the second number of times, the visit relationship of the each user.

5. The method according to claim 1, wherein the performing vector characterization learning on the group relationship and the visit relationships that are formed, to obtain the user visit inference model comprises:
performing, based on a GraphEmbeding algorithm, the vector characterization learning on the group relationship and the visit relationship of the each user that are formed, to obtain the user visit inference model.

6. The method of claim 5, wherein the performing, based on a GraphEmbeding algorithm, the vector characterization learning on the group relationship and the visit relationship of the each user that are formed, to obtain the user visit inference model, comprises:
performing, based on the GraphEmbeding algorithm, the vector characterization learning on the group relationship that is formed, to obtain a first objective function of the group relationship;
performing, based on the GraphEmbeding algorithm, the vector characterization learning on the visit relationships that are formed, to obtain a second objective function of the visit relationships; and
determining, according to the first objective function and the second objective function, the user visit inference model.

7. The method according to claim 6, wherein the determining, according to the first objective function and the second objective function, the user visit inference model comprises:
determining, using a stochastic gradient descent algorithm, the user visit inference model according to the first objective function and the second objective function.

8. An apparatus for building a user visit inference model, comprising:
a memory;
a processor; and
a computer program;
wherein the computer program is stored in the memory and when being executed by the processor, causes the processor to:
determine, according to positioning data of each user in a plurality of users, a set of staying points of the each user, wherein the set of staying points is a cluster set of staying points;
form, according to the sets of staying points of all users, a group relationship of the users;
form, according to the set of staying points of the each user, a visit relationship of the each user; and
perform vector characterization learning on the group relationship and the visit relationship of the each user that are formed, to obtain the user visit inference model.

9. The apparatus according to claim 8, wherein the positioning data comprise a position coordinate of each positioning point of the each user, a first moment when the each user reached the each positioning point, and a second moment when the each user left the each positioning point, and the computer program, when being executed by the processor, further causes the processor to:
determine, according to the first moment and the second moment, a staying time length of the each user at the each positioning point;
take a positioning point at which a staying time length is greater than a preset staying time length as the staying point of each user; and
cluster a plurality of staying points between which distance is less than preset distance, to determine the set of staying points of the each user.

10. The apparatus according to claim 8, wherein the computer program, when being executed by the processor, further causes the processor to:
determine, according to the sets of staying points of the users, a first set of users, wherein the first set of users comprise at least two users who simultaneously appeared at at least one same staying point;
count, in a preset time period, a first number of times that the at least two users in the first user set simultaneously appeared at the at least one same staying point; and
form, according to the first set of users and the first number of times, the group relationship of the users.

11. The apparatus according to claim 8, wherein the computer program, when being executed by the processor, further causes the processor to:
determine, according to the set of staying points of the each user and connection information of the each user connecting to a local area network, a visit set of the each user, wherein the visit set comprises a plurality of visit point of interests (POIs);
count, in a preset time period, a second number of times that the each user reached each visit POI in the visit set; and
form, according to the visit set and the second number of times, the visit relationship of the each user.

12. The apparatus according to claim 8, wherein the computer program, when being executed by the processor, further causes the processor to:
perform, based on a GraphEmbeding algorithm, the vector characterization learning on the group relationship and the visit relationship of the each user that are formed, to obtain the user visit inference model.

13. The apparatus according to claim 12, wherein the computer program, when being executed by the processor, further causes the processor to:
perform, based on the GraphEmbeding algorithm, the vector characterization learning on the group relationship that is formed, to obtain a first objective function of the group relationship;
perform, based on the GraphEmbeding algorithm, the vector characterization learning on the visit relationships that are formed, to obtain a second objective function of the visit relationships; and
determine, according to the first objective function and the second objective function, the user visit inference model.

14. The apparatus according to claim 13, wherein the computer program, when being executed by the processor, further causes the processor to:
determine, using a stochastic gradient descent algorithm, the user visit inference model according to the first objective function and the second objective function.

15. A computer readable storage medium having a computer program stored thereon, wherein the computer program is executed by a processor to implement the method for building a user visit inference model according to claim 1.
